(19) United States
(12) Patent Application Publication
(10) Pub. No.: US 2005/0102668 A1
(43) Pub. Date: May 12, 2005

(54) Method and device for representing the dependencies of components of a technical installation

(75) Inventor: Joachim Morgenstern, Jockgrim (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/943,963

(22) Filed: Sep. 20, 2004

Related U.S. Application Data
(63) Continuation of application No. PCT/DE03/00893, filed on Mar. 18, 2003.

(30) Foreign Application Priority Data
Mar. 18, 2002 (DE) 102 11 951.1

(51) Int. Cl. G06F 9/445; G06F 9/44

(52) U.S. Cl. 717/174; 717/168

(57) ABSTRACT

A device and method thereof for analyzing in a reliable and particularly precise manner all components of a technical installation. Underlying dependencies of the components (K1 to Kn) of the technical installation (1), particularly a power plant, are stored in a structure module (14) in order to analyze these components (K1 to Kn). The other components (K1 to Kn), which are interrelated with one component (K7, K1 to Kn) that is to be analyzed, are identified and output based on the dependencies that are stored in the structure module (14).

This is a Continuation of International Application PCT/DE03/00893, with an international filing date of Mar. 18, 2003, which was published under PCT Article 21(2) in German, and the disclosure of which is incorporated into this application by reference.

### FIELD AND BACKGROUND OF THE INVENTION

The invention relates to a method for processing components of a technical installation, particularly for analyzing the interrelationships of the components of a power plant. The invention further relates to a device for processing components of the technical installation.

Today, to control technical installations, e.g., a power plant, or products, e.g., a vehicle, data processing systems are usually used to automate the process of the installation or the product. Depending on the complexity of the technical installation, the data processing system can be comparatively large or have a decentralized structure. In other words, data processing systems are used on various scales in automation processes of the technical installation. They can be used in comparatively large and complex industrial installations or, in comparatively small components with a decentralized structure such as in mobile applications or consumer products. The data processing system always has a plurality of components, which are interlinked and networked to ensure proper operation of the installation.

Increasing safety and information requirements increase the complexity of the technical installation and thus the networking and the number of the installation components to be examined. Because of the increasing complexity and structuring of technical installations, functional testing of the components involves an extremely difficult and time-consuming analysis of component dependencies and combinations as a result of the networking.

To simplify such an analysis, the installation process, or the installation as such is typically divided into a plurality of small structograms, which make the dependencies and combinations of components for partial processes manageable for the user. One disadvantage of this method is that any change made across the installation or product is difficult to record. Furthermore, the effects of a change can be identified only in the corresponding structograms. The effects of errors on the entire installation or the entire product cannot be examined.

### OBJECTS OF THE INVENTION

Thus, one object of the invention is to provide a method for processing components of a technical installation, which enables a reliable and particularly precise analysis of all the components of the technical installation.

### SUMMARY OF THE INVENTION

According to one formulation of the invention, this object may be attained with respect to the method for processing components of a technical installation, for instance a power plant, by storing the underlying dependencies of the components in a structure module. For a component to be analyzed, other components that are interrelated with this component are identified and output on the basis of the dependencies stored in the structure module.

This aspect of the invention is based on the idea that the description of any installation can be reduced to an analysis of all its components using at least one criterion that describes them in greater detail. For this purpose, a criterion common to all components that is particularly simple and covers a large number of possible individual functions should be used for the analysis. Furthermore, the component should be processed unchanged in an analysis. Links characterizing the installation process, the installation, and/or a product, or dependencies of components are determined and analyzed as the criterion. For this purpose, the dependencies underlying the components are preferably stored in a structure module. By means of the dependencies stored in the structure module, the interaction of all the components of the entire plant is determined completely. The interrelationship is considered that feature of the component which describes the interdependencies of the components in the entire installation and thus, the processing thereof. For example, logic operations of components are considered an interrelationship. In other words, in this connection, the interrelationship describes all the dependencies of all the components in the installation, i.e., the effect that each component has on every other component, particularly an adjacent component.

In an exemplary embodiment, the linkage of pairs of components is determined as a dependency and stored in the structure module. If one of the components of the installation is modified, the knowledge required to describe and analyze the component is reduced to the analysis and processing of paired dependencies of the modified components.

The components that are interrelated with the components to be analyzed are preferably output chronologically and/or in logical sequence. For this purpose, the components interrelated with the component to be analyzed are analyzed and stored chronologically and/or logically on the basis of their influence. The components are output, particularly displayed in the form of chronologically and/or logically ordered chains.

Advantageously, a direction of action representing the interrelationship between two components is stored. This ensures that based on the component to be analyzed, all the dependencies of that component on other components are identified and established in a recursive and/or predictive manner. The analysis is independent of the type of the component. In other words, a product, module, function and/or a signal is considered a component.

To be able to chronologically analyze the corresponding effects particularly in case of a malfunction, a response time representing the interrelationship between two components is stored. As a result, in addition to identifying the sequence of the effects of the malfunction on other components, the chronological sequence, particularly the time history is analyzed and output. This makes it possible to rapidly evaluate and record the current situation in the event of a malfunction, so that responses to eliminate the malfunction can also be analyzed in their chronological relationships.

To further improve the usefulness of the structure model, the respective component is preferably assigned a weighting factor, which is stored in the structure model. This weighting factor of the respective component is preferably selected in such a way that a prioritization or hierarchical gradation of the corresponding component can be unambiguously derived therefrom. Alternatively, the weighting factor can represent a value of the corresponding component. Depending on type and configuration, the weighting factor is preferably specified as a numerical value. As an alternative or in addition, the weighting factor can be specified in the form of a functional relationship of pairs of components, particularly as a characteristic curve.

For the analysis of the processes underlying the installation, all the components are preferably stored in the structure model in a table or a database on the basis of their underlying dependencies. For example, a list of all the components is generated in the form of an allocation table, which interrelates the individual components. Depending on the degree of structuring of the installation, the components are analyzed and processed by means of the allocation table, such that a simple allocation is used to check whether or not a component forms part of another component. This is the simplest form of the allocation. In other words, the structure module is used to examine two components in relation to each other. Each component in turn is examined for effects relative to other components, such that a functional chain of interacting components is generated. These functional chains make it particularly easy for the operator personnel to see which other components, modules or products are involved in the fault message to be analyzed. This makes signal tracing and thus fault diagnosis very reliable and fast. Furthermore, an improved embodiment can be achieved by analyzing the direction of action or the response time representing the respective interrelationship of two components.

To diagnose the status of the installation, a fault signal is preferably used as the component. Depending on type and configuration, even an archived signal or a signal recorded online can be specified for the purpose of tracing. As a result, other process signals that are correlated with this online signal and thus are a possible cause for the error message can be determined very quickly and reliably.

In another application of the analysis method, a process signal is preferably selected as the component for a startup of the installation. Using the structure module, a sequence of test steps to be executed is generated for the process signal as a functional chain on the basis of the dependencies. That is to say, based on the predefined process signal, a series of technical or process steps required for testing an operation or a signal is output for the operator personnel. As an alternative or in addition, a hardware and or software module can be selected as the component. In other words, for improved clarity in the analysis of a malfunction or a startup, based on a given signal, fault signal or process signal, all the signals, modules and/or functions, which directly or indirectly process the corresponding signal, are output, particularly displayed.

Another object of the invention is attained by a device for processing components of a technical installation, particularly a power plant, including a data processing system with a detection module for determining all the components of the installation, a structure module for storing the dependencies underlying the components, and an analysis module for selecting a component to be analyzed and for identifying other components interrelated with the component to be analyzed based on the dependencies stored in the structure model. Such a device can establish the entire structure of any installation or product in detail on the basis of the component to be analyzed, irrespective of whether the component is the product itself, a module and/or a function.

Particular advantages achieved by the invention are that a suitable and particularly simple description of the connection, particularly the interrelationship among components on the basis of dual relations can be used to quickly evaluate and analyze any networked and structured process flows and/or installations with respect to their capacity and operability. Forming relations between two functions or components and evaluating them makes it possible, in particular, to selectively examine combinations of a single component. This safely eliminates a time-consuming evaluation of complex structograms. As a result, this reduction to dual relations of components enables a data and structure compression of the corresponding installation to be analyzed, e.g., by means of generating functional chains that the operator personnel can very quickly and reliably grasp. Furthermore, such a device can be used not only for process analysis but also for process control.

### BRIEF DESCRIPTION OF THE DRAWINGS

Embodiments of the invention will now be described in greater detail, by way of example, with reference to the drawings in which:

FIG. 1 is a functional diagram depicting components provided to carry out an analysis method for a technical installation;

FIG. 2 schematically depicts an embodiment of a structure module;

FIG. 3 depicts an automation structure in the form of a functional chain;

FIG. 4 shows a comparison of the functional chains Wn to identify a change in the plant process or automation process;

FIG. 5 depicts changes in a plant structure resulting from functional expansion;

FIG. 6 illustrates the interdependency of components using a weighting factor G; and

FIG. 7 illustrates an analysis of weighting factors G conducted by an analysis module on the basis of a function Fj.

### DETAILED DESCRIPTION OF THE EXEMPLARY EMBODIMENTS

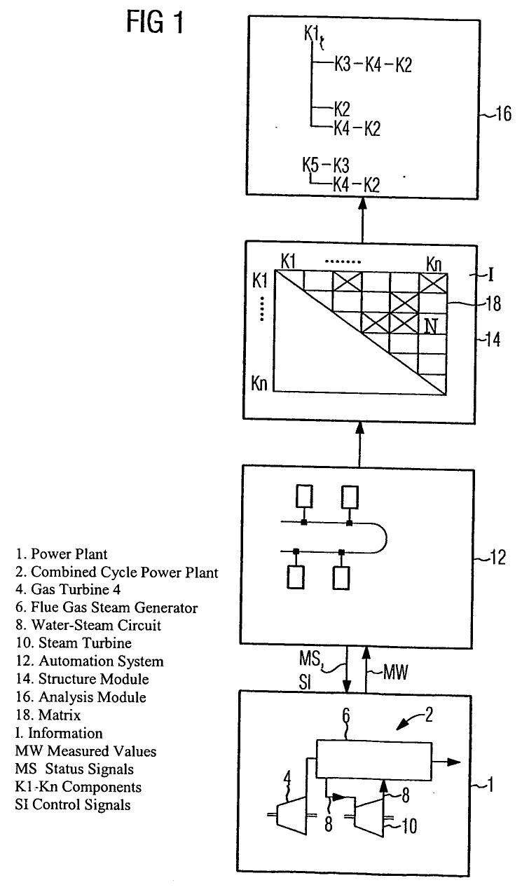

FIG. 1 schematically shows a power plant 1 as a technical installation. The power plant 1 is a combined cycle power plant 2. The combined cycle power plant 2 has a gas turbine 4 and a flue gas steam generator 6, which is connected downstream on the flu gas side and the heating surfaces of which are tied into the water-steam circuit 8 of a steam turbine 10.

Measured values MW recorded by sensors (not depicted) and status signals MS transmitted by signaling elements (not depicted) are supplied to an automation system 12. The automation system 12 processes the measured values MW and the status signals MS. Control signals SI may be transmitted to components of the combined cycle power plant 2. The processes running within the automation system 12 automatically control and monitor the combined cycle power plant 2. Structurally, the plant process of the combined cycle power plant 2 and the automation process of the automation system 12 are divided into a plurality of components K1 to Kn.

The components K1 to Kn denote both software components and hardware components, particularly products. For example, a component K1 to Kn can represent a product Pa to Pz, a module Ma to Mz, a function Fa to Fz and/or a signal Sa to Sz.

Depending on the type and configuration of the combined cycle power plant 2, which is defined as component K1, the plant includes, for example, in the case of a software product that is a subroutine of a computer program, a series of modules Ma to Mz with associated functions Fa to Fz executed in technical process steps, which in turn may process signals Sa to Sz, which can be determined and processed as successive components K2 to Kn.

For example, the component K1 includes the combined cycle power plant 2 as product Pa, the modules Ma, Mb, Mc and Md, that is, the gas turbine 4 (=module Ma), the flue gas steam generator 6 (=module Mb), the water-steam cycle 8 (=module Mc) and the steam turbine 10 (=module Md). Furthermore, the individual modules Ma, Mb, Mc, and Md can in turn include the functions Fa, Fb, Fc, Fd to Fz as additional components Kn. For example, the module Ma, i.e., the gas turbine 4, includes the function Fa, “emergency pump shutoff.” This function Fa, “emergency pump shutoff” is described by a combination of process steps, which generate control signals SI as signals Sa to Sz, as follows: “shut off pump power supply” (signal Sa), “block pump feed and discharge lines” (signal Sb) and “activate standby pump” (signal Sc).

Hence, for the component K1—the combined cycle power plant 2—the product Pa is a plurality of modules Ma to Mz, which in turn include a plurality of functions Fa to Fz including, in turn, a plurality of signals Sa to Sz. For example, in the alternative combined cycle power plant 2 defined as component K2 and product Pb, only one gas turbine 4 is processed as module Ma. Depending on the function of the respective combined cycle power plant 2, the components K1 to Kn are correspondingly combined and structured.

To analyze the structure of the plant process of the combined cycle power plant 2 and the automation process of the automation system 12, a structure module 14 is provided, in which the dependencies underlying the components K1 to Kn are stored as information I. Using the structure module 14, the components K1 to Kn are established in relation to each other by means of a list that includes all the components K1 to Kn, i.e., all the products Pa to Pz, all the modules Ma to Mz and all the functions Fa to Fz on the basis of the underlying correlations or dependencies. In other words, the dependencies of all the components K1 to Kn are determined and allocated, for example, by means of a table. As one alternative to the table, for example, a database may be used.

Depending on the type and configuration of the structure module 14, the products Pa to Pz, modules Ma to Mz, functions Fa to Fz and/or signals Sa to Sz representing the components K1 to Kn are determined and stored chronologically or hierarchically. Alternatively, a structure module 14 can be provided for each component K1 to Kn. For example, only the products Pa to Pz and their dependencies are stored in a structure module 14.

To analyze a type of the combined cycle power plant 2, the product Pa is selected as the component K1 to be analyzed. For this purpose, an analysis module 16 is provided, which uses information I stored in the structure module 14 to identify and output the other components K2 to Kn that are interrelated with this component K1. Depending on the type and configuration of the analysis module 16, the analysis method can be carried out in a recursive or predictive manner. In other words, based on the component K1 to be analyzed, the subsequent combinations or dependencies with other components K2 to Kn in the process flow or the automation process are identified and analyzed using the analysis module 16. Thus, the analysis method is suitable for any analysis based on any point or feature, i.e., any product Pa to Pz, module Ma to Mz or function Fa to Fz.

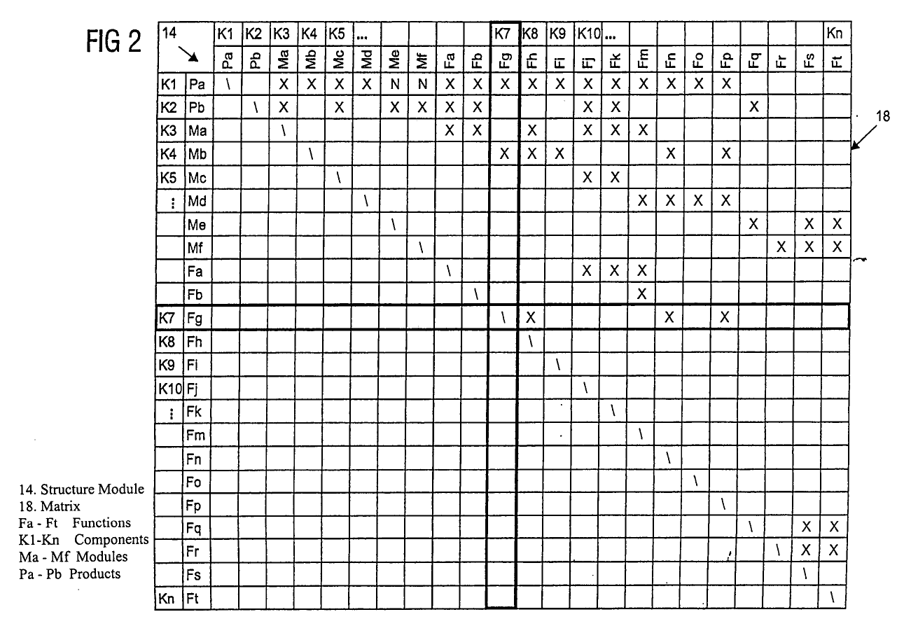

FIG. 2 shows an embodiment of the structure module 14 in the form of a table. All the components K1 to Kn of the technical installation 1 are recorded, for example, in the form of a list. The components K1 to Kn then form both the lines and the columns of a matrix 18. The interdependencies of the individual components K1 to Kn are arranged in the matrix 18. This is indicated, for example, by the capital letters X and N. Components K1 to Kn that depend on each other are identified by X. Components K1 to Kn that may not be linked with each other are identified by the capital letter N. Thus, using the structure module 14, the entire plant process or automation process is analyzed and structured by means of simple pair relationships. The simplest form is the table form. As an alternative, the relationship of two components K1 to Kn can also be described and recorded using a function diagram or some other way known to skilled artisans of representing a combination structure.

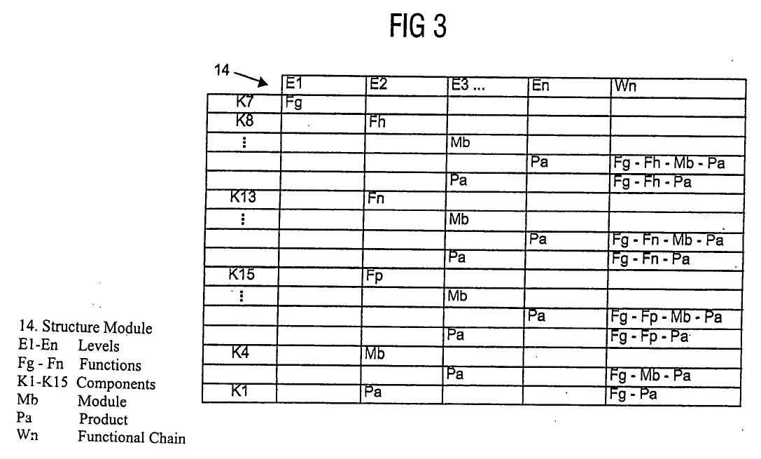

In the analysis of the combined cycle power plant 2, the dependencies of the components K1 to Kn stored in the structure module 14 as information 1 are analyzed by the analysis module 16. For this purpose, based on a component K1 to Kn to be analyzed, e.g., based on the component K7, the other components K1 and K4 and, respectively, K8, K13 and K15, which are interrelated with this component K7, are determined chronologically and/or in logical sequence. The component K7 to be analyzed is defined as the base component of a first level E1. The other dependent components K1, K4, K8, K13 and K15 determined by the structure module 14 are assigned to another, second level E2. The components K1, K4, K8, K13 and K15 assigned to the second level E2 are then in turn examined for dependencies of further components K1 to Kn. The further components K1 and K4 that are identified and depend on the components K1, K4, K8, K13 and K15 of the level E2 are assigned to a further level E3. The analysis module 16 executes this algorithm until no further dependencies of components K1 to Kn are identified. Establishing levels E1 to En in this manner thus describes the branching or nesting of the dependencies of components K1 to Kn in the manner of a tree structure. The sum of all the basic features of the level E1 thus represents the entire plant structure, or the entire automation structure in the form of branches or functional chains Wn based on the component K7 to be analyzed. Such a branch or functional chain Wn is depicted in FIG. 3.

FIG. 3 shows the functional chain Wn for the components K1, K4, K8, K13 and K15, which are interrelated with the component K7 to be analyzed. Depending on the type and configuration of the analysis module 16, this functional chain Wn is determined and output chronologically, i.e., as a function of time, and/or in logical sequence. A sub-branch represents a partial structure of the plant 1 or the automation process in the form of partial chains.

As an alternative, depending on the default, the respective functional chain Wn in accordance with FIG. 3 can be output in a predictive and/or retrospective manner. For this purpose, the analysis module 16 is used to determine and analyze a direction of action representing the interrelationship between two components K1 to Kn, which is stored in the structure module 14 as information I. In another preferred embodiment, a response time representing the interrelationship between components K1 to Kn can be determined and analyzed in addition to the direction of action of the interrelationships of a plurality of components K1 to Kn.

Generating and outputting functional chains Wn for the plant process or automation process in this manner makes it possible, for example, to conduct a particularly simple test routine supporting the operator personnel when the combined cycle power plant 2 is started up. For improved clarity, based on the predefined component K7, all the modules Ma to Mz and functions Fa to Fz, which directly or indirectly process the component K7, are processed and output as components K1 to Kn.

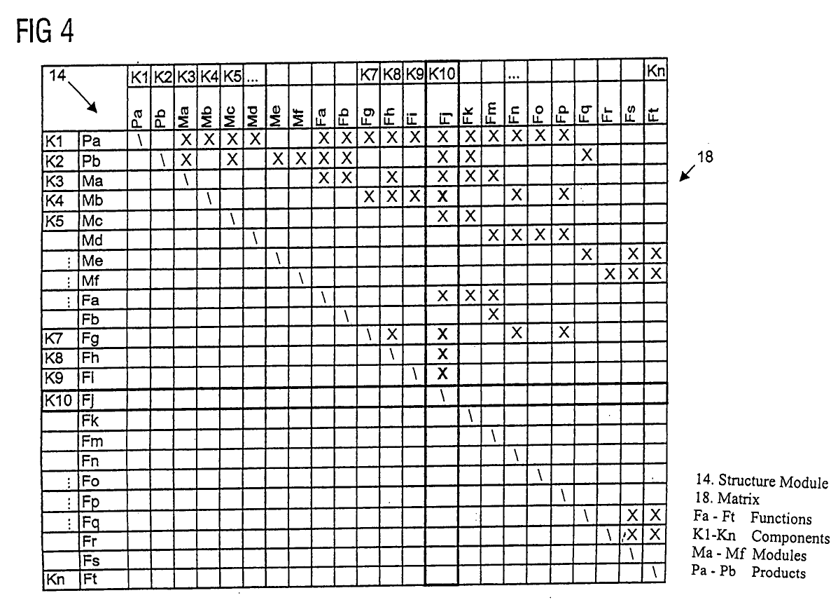

In another application case, the functional chains Wn can be compared to identify a change in the plant process or automation process. An example of this is shown in FIG. 4 using the expansion of the component K10, i.e., the expansion of the function Fj by other dependencies on the module Mb and the functions Fg, Fh and Fi (Xs in bold face).

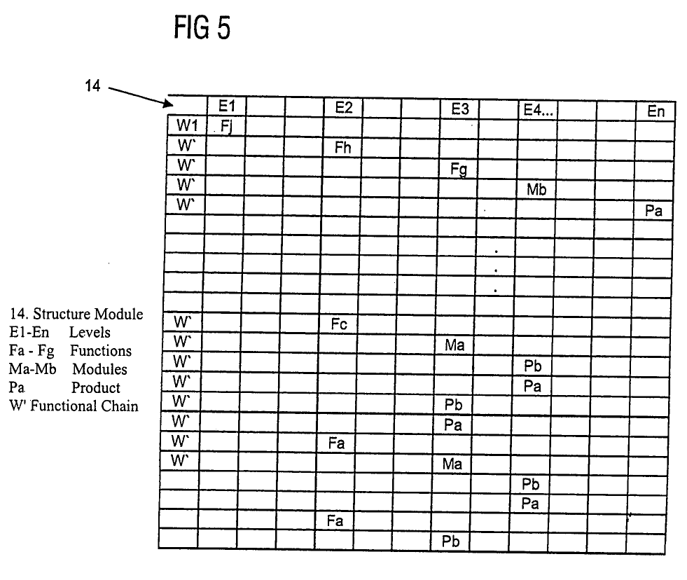

FIG. 5 depicts the changes in the plant structure resulting from the functional expansion. FIG. 5 shows the functional chain Wn generated by the analysis module 16 using the structure module 14. Both the functional chains W generated before the change in the function Fj and the functional chains W′n generated after the change in the function Fj are shown. The newly determined functional chains W′n were identified by the analysis module 16 based on a comparison of previous and current functional chains Wn before and after the change.

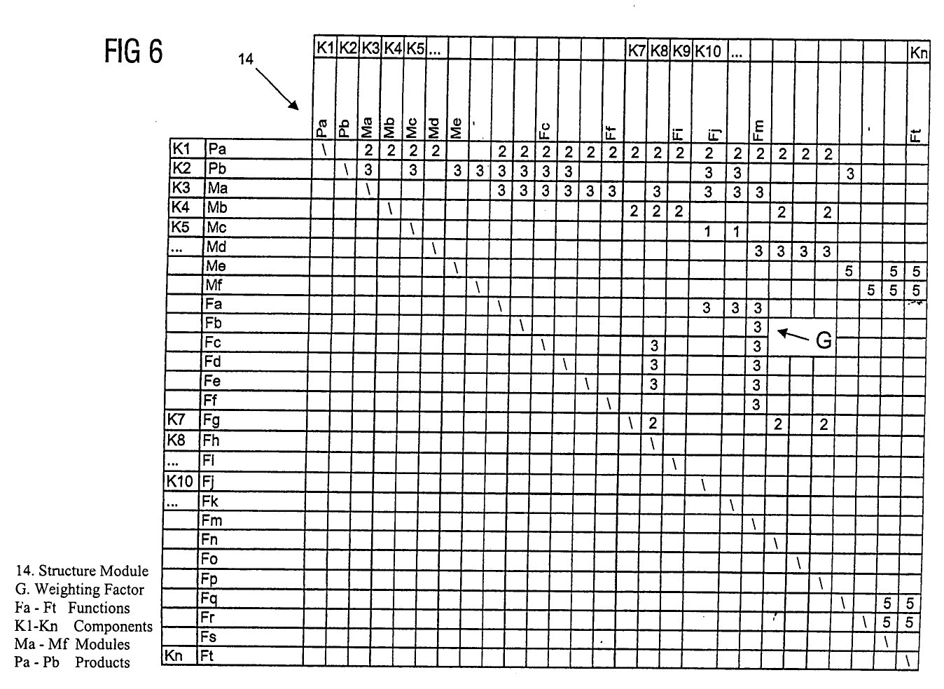

Instead of using and comparing functional chains Wn, the interdependency of the components K1 to Kn can be described using a weighting factor G. For example, in FIG. 6, a weighting factor G for the respective component K1 to Kn is stored in the structure module 14 as information I in the form of a priority 1 to 5.

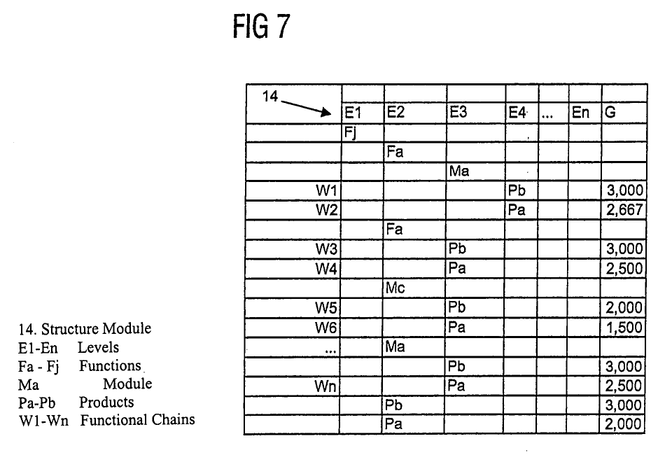

FIG. 7 illustrates an analysis of the weighting factors G conducted by the analysis module 16 on the basis of the function Fj. The weighting factors G stored in the structure module 14 are used to calculate a mean of the components K1 to Kn, which form a single functional chain Wn. The value calculated for the corresponding functional chain Wn represents the degree of correlation of the corresponding components K1 to Kn of a single functional chain Wn. A particularly small mean value of 1.5 for the weighting factors G of the corresponding functional chain W6 represents a particularly high degree of correlation of the corresponding components K1 to Kn.

The analysis method described here can also be used for process control. For example, simple descriptions of relations between different components K1 to Kn of the combined cycle power plant 2 are used to represent chronologically executed process steps: “switch on pump A,” “pressure A increases,” “open sampling valve B,” “pressure A drops.” To analyze a malfunction, the analysis module 16 is then used to identify and analyze the status signal MS “leak in pipe” as component K1 to Kn by the structure module 14.

Based on the functional chains Wn generated by the structure module 14, the effects of the malfunction are identified before the actual signals subsequently detected by the plant process occur, so that corresponding control signals SI can be generated. For example, the structure module 14 detects that the pressure is dropping. By analyzing the dependencies using the structure module 14, the standby pump is then automatically switched on as one possible response to correct the malfunction even before the actual status signal MS “pressure drop” is detected. As an alternative a sampling can be reduced. Depending on the type and configuration of the structure module 14, if additional information I is stored in the structure module 14, e.g., response times or operating characteristics, the operation of the plant under the effect of the identified malfunction is predicted and described. Thus, the analysis method described herein can be used not only for process control but also for process analysis, simulation or for a forecast of a technical installation.

The above description of the exemplary embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for processing components of a technical installation comprising:
storing underlying dependencies of the components in a structure module; and
analyzing at least one of the components, wherein, others of the components interrelated with the at least one component are identified and output in accordance with the dependencies stored in the structure module.

2. The method as claimed in claim 1, wherein the components interrelated with the at least one component are output at least one of chronologically and in logical sequence.

3. The method as claimed in claim 1, wherein a direction of action representing the interrelationship between two components is stored in the structure module.

4. The method as claimed in claim 1, wherein a response time representing an interrelationship between two components is stored in the structure module.

5. The method as claimed in claim 1, wherein the at least one of the components is assigned a weighting factor, which is stored in the structure module.

6. The method as claimed in claim 1, wherein all of the components are stored in the structure module on the basis of their underlying dependencies using at least one of a table and a database.

7. The method as claimed in claim 1, wherein a fault signal is selected as the at least one component for said analyzing.

8. The method as claimed in claim 1, wherein a process signal is selected as the at least one component for said analyzing.

9. The method as claimed in claim 1, wherein at least one of a hardware and a software module is selected as the at least one component for said analyzing.

10. The method as claimed in claim 1, wherein the technical installation is a power plant.

11. A device for processing components of a technical installation, comprising:
a data processing system including a structure module storing dependencies underlying the components; and
an analysis module for selecting at least one of the components to be analyzed and identifying others of the components interrelated with the at least one component to be analyzed using the dependencies stored in the structure module.

12. The device as claimed in claim 11, further comprising a detection module to determine all the components of the installation.

13. The device as claimed in claim 11, wherein the technical installation is a power plant.

14. A computer readable medium having a program comprising instructions for processing components of a technical installation, the instructions, when executed:
store underlying dependencies of the components in a structure module; and
analyze at least one of the components, wherein, other components interrelated with the at least one of the components are identified and output using the dependencies stored in the structure module.
